(19) United States
(12) Patent Application Publication
(10) Pub. No.: US 2023/0196321 A1
(43) Pub. Date: Jun. 22, 2023

(54) MOBILE TERMINAL AND METHOD FOR RETAIL TRANSACTION SETTLEMENT PROCESSING

(71) Applicant: TOSHIBA TEC KABUSHIKI KAISHA, Tokyo (JP)

(72) Inventor: Nobuyuki TAKAHASHI, Tagata Shizuoka (JP)

(21) Appl. No.: 17/960,766

(22) Filed: Oct. 5, 2022

(30) Foreign Application Priority Data
Dec. 21, 2021 (JP) 2021-207511

(51) Int. Cl. G06Q 20/18; G06Q 20/32; G06Q 10/02

(52) U.S. Cl. CPC G06Q 20/18; G06Q 20/3263; G06Q 10/02

(57) ABSTRACT

According to one embodiment, a mobile terminal for use in a self-service checkout system includes a processor, a communication interface connectable to a reservation management server, and a display screen. The processor receives product identification information for identifying a product to be purchased in a sales transaction, and displays a reservation request screen on the display screen to receive a reservation request for which a reservation time for using an accounting device for settlement processing of the sales transaction is set. The processor sends the reservation request to the reservation management server via the communication interface and receives a reservation request response from the reservation management server. The reservation request response includes reservation information when the reservation request is accepted by the reservation management server. The mobile terminal outputs identification information corresponding to the reservation information if the reservation request is accepted by the reservation management server.

### CROSS-REFERENCE TO RELATED APPLICATION

This application is based upon and claims the benefit of priority from Japanese Patent Application No. 2021-207511, filed Dec. 21, 2021, the entire contents of which are incorporated herein by reference.

### FIELD

An embodiment described herein relates to a mobile terminal and a method.

### BACKGROUND

In the related art, a retail store system in which a customer collects the products to be purchased and registers each product for purchase using a mobile terminal in a retail store such as a supermarket is known. The customer in such a system then uses an accounting device (e.g., a payment kiosk or the like) to pay for the registered products.

However, in some circumstances, the customer may have to wait an accounting device to become available for use.

### BRIEF DESCRIPTION OF THE DRAWINGS

FIG. 1 is a diagram illustrating an example of a self-checkout system according to an embodiment.

FIG. 2 is a block diagram of a management server.

FIG. 3 is a block diagram of a mobile terminal.

FIG. 4 is a block diagram of an accounting device.

FIG. 5 is a block diagram of a self-checkout system.

FIG. 6 is a diagram illustrating an example of a product registration screen.

FIG. 7 is a diagram illustrating an example of an account reservation screen.

FIG. 8 is a diagram illustrating an example of a reservation success screen.

FIG. 9 is a diagram illustrating an example of a reservation failure screen.

FIG. 10 is a diagram illustrating an example of a reminder screen.

FIG. 11 is a diagram illustrating an example of a reception screen.

FIG. 12 is a diagram illustrating an example of an in-reserve screen.

FIG. 13 is a flowchart of an account reservation executed by the mobile terminal.

FIG. 14 is a flowchart of a reservation executed by a mobile terminal and a management server.

FIG. 15 is a flowchart of a reserved account executed by an accounting device.

### DETAILED DESCRIPTION

An embodiment provides a mobile terminal and a method that can reduce waiting times for an accounting device.

According to one embodiment, a mobile terminal for use in a self-service checkout system includes a processor, a communication interface connectable to a reservation management server, and a display screen. The processor receives an input of product identification information for identifying a product to be purchased in a sales transaction, and displays a reservation request screen on the display screen to receive a reservation request for which a reservation time for using an accounting device for settlement processing of the sales transaction is set. The processor sends the reservation request to the reservation management server via the communication interface and receives a reservation request response from the reservation management server. The reservation request response includes reservation information when the reservation request is accepted by the reservation management server. The processor outputs identification information corresponding to the reservation information if the reservation request is accepted by the reservation management server.

Hereinafter, certain example embodiments of a mobile terminal and a method for a retail checkout system will be described with reference to the drawings. The embodiments are only examples and do not limit the present disclosure.

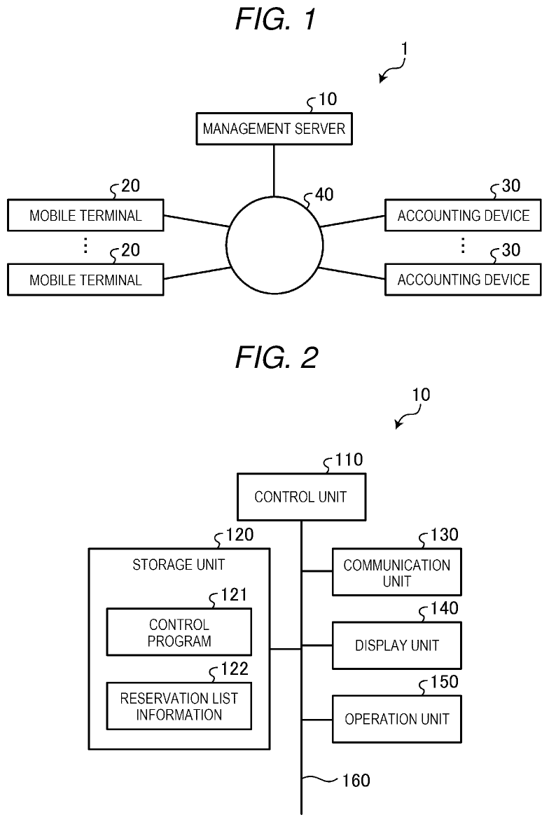

FIG. 1 is a diagram illustrating an example of a self-checkout system 1 according to the present embodiment. The self-checkout system 1 is a system for a shop or retail store by which a customer registers a product to be purchased and then pays for the registered product.

The self-checkout system 1 includes a management server 10, a plurality of mobile terminals 20, and a plurality of accounting devices 30. The management server 10, the mobile terminals 20, and the accounting devices 30 communicate with each other via a network 40.

The management server 10 is a server device such as a personal computer or cloud computing device. The management server 10 is not limited to one server device, and may comprise a plurality of server devices. In the self-checkout system 1, the management server 10 manages reservations for the accounting devices 30.

Each of the mobile terminals 20 is a terminal such as a smartphone or a tablet terminal that can be carried by a customer. For example, the mobile terminal 20 may be a terminal owned by the customer or may be lent to the customer by the retail store for use in the retail store. The mobile terminal 20 registers a product to be purchased when selected by the customer in the retail store. The mobile terminal 20 receives a reservation for an accounting device 30. In this context, an accounting device 30 is a device that can be used by the customer to pay for the registered product(s).

That is, the products registered by the customer using the mobile terminal 20 are subsequently paid for at an accounting device 30. The accounting device 30 receives a reservation specifying time for the customer carrying the mobile terminal 20 to use the device. For a reserved time period (slot), the accounting device 30 determines whether the particular customer has a reservation or not. When the customer has a reservation, the accounting device 30 is available for transaction settlement (e.g., receive payment). In other words, in this example, a customer who has no reservation is not allowed to use the accounting device 30 during an otherwise reserved time period.

In this way, the self-checkout system 1 receives reservations for the accounting devices 30. When an accounting device 30 is reserved, the self-checkout system 1 allows the reserving customer to use the accounting device 30 but does not allow any other customers to use the accounting device 30 in the reserved time period. Since the other customers can not use the accounting device 30 in the reserved time period, the customer who has a reservation can use the accounting device 30 without waiting for an accounting device 30 to become available.

Next, a hardware configuration of various devices of the self-checkout system 1 will be described.

FIG. 2 is a block diagram illustrating an example of a hardware configuration of the management server 10. The management server 10 includes a control unit 110, a storage unit 120, a communication unit 130, a display unit 140, and an operation unit 150. The units connect to each other via a system bus 160 such as a data bus or an address bus.

The control unit 110 controls operations of the management server 10 and implements various functions of the management server 10. The control unit 110 includes a processor, a read only memory (ROM), and a random access memory (RAM). The processor is a processing device such as a central processing unit (CPU) that controls the operation of the management server 10. The ROM is a storage medium that stores various programs and data. The RAM is a storage medium that temporarily stores various programs and various data. The processor executes a program stored in the ROM, the storage unit 120, or the like using the RAM as a work area.

The storage unit 120 is a storage device such as a hard disk drive (HDD) or a solid-state drive (SSD). The storage unit 120 stores a control program 121 and reservation list information 122. The reservation list information 122 is not limited to being stored in the management server 10, and may be stored in another device.

The control program 121 is a program providing instructions for performing various functions in conjunction with an operating system or the like.

The reservation list information 122 is information in which a reservation status of the accounting devices 30 is registered. More specifically, in the reservation list information 122, reservation content information is associated with each of a plurality of accounting device codes. Each of the accounting device codes is identification information for identifying the accounting device 30. The reservation content information is information indicating details for a reservation of an accounting device 30. The reservation content information includes reservation identification information and reservation time point information. The reservation identification information is identification information used to determine whether a customer who desires to use the accounting device 30 has a reservation. For example, the reservation identification information may be a customer code for identifying the customer, a mobile terminal code for identifying the mobile terminal 20 used by the customer who has a reservation, dedicated identification information generated for a reservation, or other information. The reservation time point information is information including a reserved start time point and a restriction period during which use by a customer other than the customer who has a reservation is restricted (prevented).

The communication unit 130 is an interface that communicates with an external device via the network 40. For example, the communication unit 130 communicates with the mobile terminals 20 and the accounting devices 30.

The display unit 140 is a display device that displays various screens. For example, the display unit 140 is a liquid crystal display.

The operation unit 150 is an input device such as a keyboard or a mouse that receives various operations.

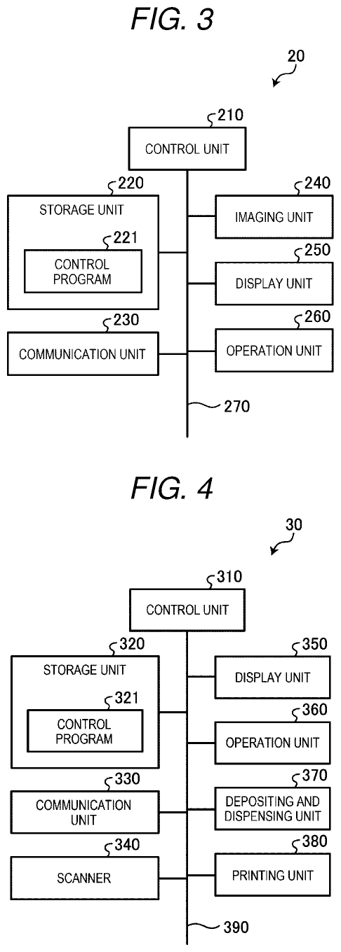

FIG. 3 is a block diagram illustrating an example of a hardware configuration of the mobile terminal 20. The mobile terminal 20 includes a control unit 210, a storage unit 220, a communication unit 230, an imaging unit 240, a display unit 250, and an operation unit 260. The units connect to each other via a system bus 270 such as a data bus or an address bus.

The control unit 210 controls operations of the mobile terminal 20 and implements various functions of the mobile terminal 20. The control unit 210 includes a processor, a ROM, and a RAM. The processor is a processing device such as a CPU that controls the operation of the mobile terminal 20. The ROM is a storage medium that stores various programs and data. The RAM is a storage medium that temporarily stores various programs and various data. The processor executes a program stored in the ROM, the storage unit 220, or the like using the RAM as a work area.

The storage unit 220 is a storage device such as a flash memory. The storage unit 220 stores a control program 221. The control program 221 is a program including instructions for providing functions in conjunction with an operating system or the like.

The communication unit 230 is an interface that communicates with an external device via the network 40. For example, the communication unit 230 communicates with the management server 10.

The imaging unit 240 is a camera including an imaging element such as a complementary metal-oxide semiconductor (CMOS) or a charge coupled device (CCD).

The display unit 250 is, for example, a touch panel display. The display unit 250 receives an operation corresponding to a display content.

The operation unit 260 is one or more buttons or the like for receiving various operations from a user.

FIG. 4 is a block diagram illustrating an example of a hardware configuration of the accounting device 30. The accounting device 30 includes a control unit 310, a storage unit 320, a communication unit 330, a scanner 340, a display unit 350, an operation unit 360, a depositing and dispensing unit 370, and a printing unit 380. The units connect to each other via a system bus 390 such as a data bus or an address bus.

The control unit 310 controls operations of the accounting device 30 and implements various functions of the accounting device 30. The control unit 310 includes a processor, a ROM, and a RAM. The processor is a processing device such as a CPU that controls the operation of the accounting device 30. The ROM is a storage medium that stores various programs and data. The RAM is a storage medium that temporarily stores various programs and various data. The processor executes a program stored in the ROM, the storage unit 320, or the like using the RAM as a work area.

The storage unit 320 is a storage device such as an HDD or an SSD. The storage unit 320 stores a control program 321. The control program 321 includes instructions for providing functions of the accounting device 30 in conjunction with an operating system or the like.

The communication unit 330 is an interface that communicates with an external device via the network 40. For example, the communication unit 330 communicates with the management server 10.

The scanner 340 is a camera including an imaging element such as a CMOS or a CCD. The scanner 340 reads a code symbol such as a barcode or a two-dimensional code.

The display unit 350 is a display device that displays various screens. For example, the display unit 350 is a liquid crystal display.

The operation unit 360 is an input device that receives various operations. For example, the operation unit 360 is a touch pad or a button provided on the display unit 350.

The depositing and dispensing unit 370 is an automatic change machine that receives deposits of money as payment and dispenses money as change or the like during transaction settlement. The depositing and dispensing unit 370 stores, in an accommodation unit, money such as coins and bills deposited from a depositing port. The depositing and dispensing unit 370 dispenses, as change, money such as coins and bills from the accommodation unit to a dispensing port.

The printing unit 380 is a printer that prints various types of information. For example, the printing unit 380 prints a receipt.

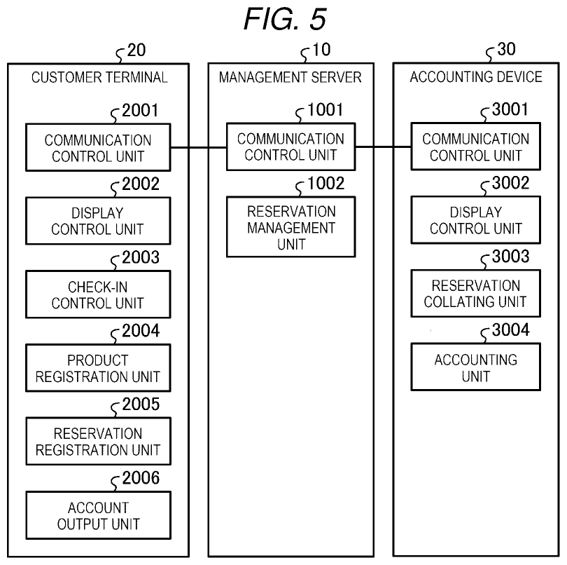

Next, functions of various devices of the self-checkout system 1 will be described. FIG. 5 is a block diagram showing an example of functional configurations of the various devices of the self-checkout system 1.

The processor included in the control unit 210 of the mobile terminal 20 loads the control program 221 stored in the storage unit 220 into the RAM and operates according to the control program 221 to generate various functional units in the RAM. Accordingly, the control unit 210 of the mobile terminal 20 includes as functional units: a communication control unit 2001, a display control unit 2002, a check-in control unit 2003, a product registration unit 2004, a reservation registration unit 2005, and an account output unit 2006.

The communication control unit 2001 controls the communication unit 230 to communicate with the management server 10. For example, the communication control unit 2001 transmits reservation request information for requesting a reservation for an accounting device 30 to the management server 10. The communication control unit 2001 receives, from the management server 10, reservation success or failure information indicating whether the reservation for the accounting device 30 has succeeded.

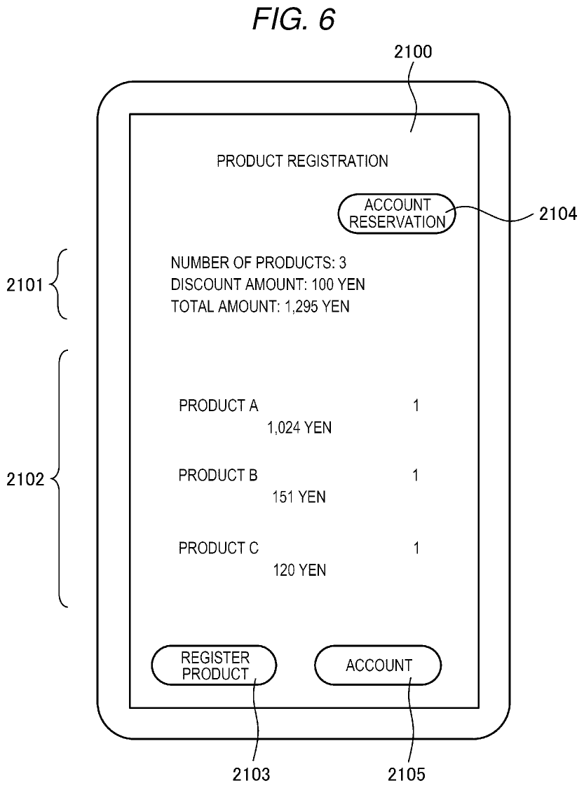

The display control unit 2002 controls the display unit 250 to display various screens. For example, the display control unit 2002 displays a product registration screen 2100 on the display unit 250. FIG. 6 is a diagram illustrating an example of the product registration screen 2100. For example, the product registration screen 2100 includes a counting display area 2101, a product list display area 2102, a product registration button 2103, an account reservation button 2104, and an account button 2105. The counting display area 2101 is an area for displaying a counting result of the registered products. For example, the display control unit 2002 displays, in the counting display area 2101, the total number, a total amount, a total discount amount, and the like of the registered products.

The product list display area 2102 is an area for displaying a list of the registered products. The product registration button 2103 is a button for receiving an operation of displaying a product code input screen. The product code input screen is a screen for receiving an input of a product code when registering the product. For example, the product code input screen is a screen for imaging the code symbol (such as a barcode) attached to the product by displaying image data provided by the imaging unit 240. The mobile terminal 20 receives the input of the product code by decoding the barcode. The product code input screen is not limited to imaging the product code, and may receive a manual input of the product code by a user input operation or the like.

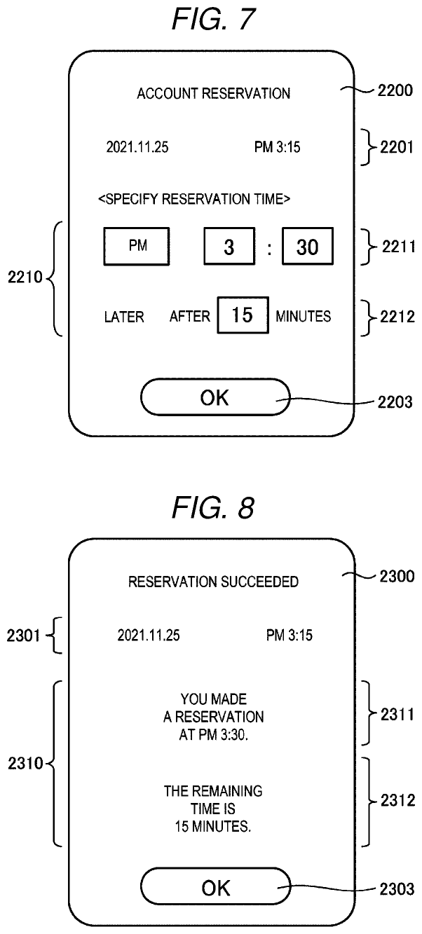

The account reservation button 2104 is a button for receiving an input operation for displaying an account reservation screen 2200 (see FIG. 7). The account button 2105 is a button for receiving an input operation for displaying an account information output screen.

When the account reservation button 2104 is pressed, the display control unit 2002 displays the account reservation screen 2200 on the display unit 250. FIG. 7 is a diagram illustrating an example of the account reservation screen 2200. The account reservation screen 2200 is a screen for receiving an input operation for reserving an accounting device 30. The account reservation screen 2200 includes a current time point display area 2201, a reservation time input area 2210, and an OK button 2403.

The current time point display area 2201 is an area for displaying current time point. The reservation time input area 2210 is an area for inputting of a reservation time for reserving an accounting device 30. The reservation time input area 2210 includes a time point input area 2211 and an elapsing time input area 2212. The time point input area 2211 is an area in which the reservation time is input as a time point. The elapsing time input area 2212 is an area in which the reservation time is input as an elapsing time.

Although the reservation time input area 2210 shown in FIG. 7 includes both the time point input area 2211 and the elapsing time input area 2212, the reservation time input area 2210 may include just one of the time point input area 2211 or the elapsing time input area 2212 in other examples. Although in the reservation time input area 2210 shown in FIG. 7, both the time point input area 2211 and the elapsing time input area 2212 are displayed, just one of the time point input area 2211 or the elapsing time input area 2212 may be provided. The OK button 2403 is a button for receiving an input operation of reserving the accounting device 30 at the indicated reservation time in the reservation time input area 2210. When the OK button 2403 is pressed, the communication control unit 2001 transmits the reservation request information to the management server 10. The communication control unit 2001 receives the reservation success or failure information as a response to the reservation request information.

When the reservation success or failure information indicates success of the reservation, the display control unit 2002 displays a reservation success screen 2300 on the display unit 250. FIG. 8 is a diagram illustrating an example of the reservation success screen 2300. The reservation success screen 2300 is a screen indicating that the reservation about the accounting device 30 succeeded. The reservation success screen 2300 includes a current time point display area 2301, a reservation time display area 2310, and an OK button 2403.

The current time point display area 2301 is an area for displaying the current time. The reservation time display area 2310 is an area for displaying the reservation time. The reservation time display area 2310 includes a reservation time point area 2311 and a remaining time display area 2312. The reservation time point area 2311 is an area for displaying the time for which the accounting device 30 is reserved. The remaining time display area 2312 is an area for displaying the remaining time until the reservation time. In other words, the remaining time display area 2312 is an area for displaying the time still remaining to continue registering products to be purchased. The OK button 2403 is a button for receiving an operation of closing the reservation success screen 2300.

When the reservation success or failure information includes an accounting device code indicating the particularly reserved accounting device 30, the display control unit 2002 may display, on the reservation success screen 2300, an image indicating the particularly reserved accounting device 30 or a location where the reserved accounting device 30 is disposed. Accordingly, the customer can know which accounting device 30 among a plurality of accounting devices 30 is reserved.

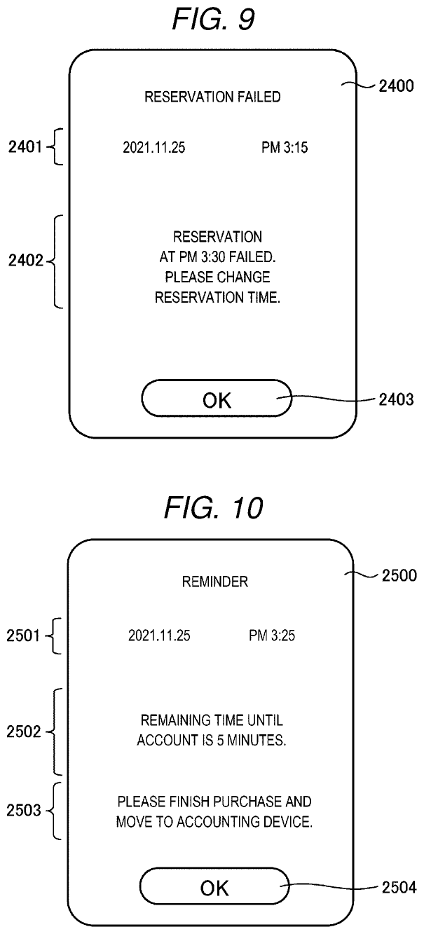

When the reservation success or failure information indicates a reservation failure, the display control unit 2002 displays a reservation failure screen 2400 on the display unit 250. FIG. 9 is a diagram illustrating an example of the reservation failure screen 2400. The reservation failure screen 2400 is a screen indicating that the attempted reservation of an accounting device 30 failed. The reservation failure screen 2400 includes a current time point display area 2401, a failure time point display area 2402, and an OK button 2403. The current time point display area 2401 is an area for displaying the current time point. The failure time point display area 2402 is an area for indicating that an accounting device 30 is not reservable at the requested reservation time. The OK button 2403 is a button for receiving an operation of closing the reservation failure screen 2400.

When the reservation success or failure information indicating that the reservation about the accounting device 30 failed includes another time at which the accounting device 30 is reservable, the display control unit 2002 may display, on the reservation failure screen 2400, the time at which a reservation could be made. Accordingly, the customer can know the time at which another reservation can be made.

The display control unit 2002 displays on the display unit 250 a reminder screen 2500 based on the remaining time until the reserved reservation time. For example, when the remaining time until the reservation time included in the reservation content stored in the storage unit 220 is a set value, the display control unit 2002 displays the reminder screen 2500. When the communication control unit 2001 receives a notification indicating that the remaining time until the reserved reservation time is the set value, the display control unit 2002 may display the reminder screen 2500.

FIG. 10 is a diagram illustrating an example of the reminder screen 2500. The reminder screen 2500 is a screen for notifying the customer of the remaining time until the reserved reservation time. The reminder screen 2500 includes a current time point display area 2501, a remaining time display area 2502, a message display area 2503, and an OK button 2504. The current time point display area 2501 is an area for displaying the current time point. The remaining time display area 2502 is an area for displaying the remaining time until the reserved reservation time. The message display area 2503 is an area for displaying a message prompting the customer to end registering products to be purchased and move to the accounting device 30 since the remaining time until the reserved reservation time is short. The OK button 2504 is a button for receiving an operation of closing the reminder screen 2500.

When the reservation success or failure information includes the accounting device code indicating the reserved accounting device 30, the display control unit 2002 may display, on the reminder screen 2500, the image indicating the reserved accounting device 30 or the location where the reserved accounting device 30 is disposed. Accordingly, the customer can know which accounting device 30 is reserved.

When the account button 2105 of the product registration screen 2100 is pressed, the display control unit 2002 displays the account information output screen on the display unit 250. For example, the account information output screen is a screen including a code symbol such as a barcode or a two-dimensional code. The code symbol is an image including reservation identification information and acquisition information for acquiring product registration information. The product registration information is information on the registered products that have been registered with the mobile terminal 20. For example, the product registration information is information such as a name, a price, and the number of items being purchased. The acquisition information is information for downloading the product registration information from a server device such as the management server 10. For example, the acquisition information is information for specifying the product registration information from among a plurality of such information managed by the management server 10 or the like. The reservation identification information is information corresponding to the reservation for the accounting device 30. When the reservation identification information coincides with the reservation identification information, the accounting device 30 downloads the product registration information using the acquisition information. The accounting device 30 then performs settlement processing (payment processing) based on the product registration information.

For example, when the reservation success or failure information includes the reservation identification information, the display control unit 2002 may display the code symbol indicating the reservation identification information. Alternatively, when the reservation identification information is a fixed value such as a customer code, the display control unit 2002 may display a code symbol based on the corresponding information. The acquisition information and the reservation identification information are not limited to being in the same code symbol, and may be included in different code symbols. That is, the mobile terminal 20 may read or provide a code symbol twice at the accounting device 30.

The display control unit 2002 displays on the display unit 250 a reservation cancellation screen when the reservation time elapsed. The display control unit 2002 is an example of a display control unit. The reservation cancellation screen is a screen indicating that the reservation for the accounting device 30 is cancelled because the reservation time elapsed. For example, the reservation cancellation screen includes the reserved reservation time, a message indicating that the reservation for the accounting device 30 is cancelled, a message indicating the accounting device 30 may be reserved again, and a button for closing the reservation cancellation screen.

The check-in control unit 2003 checks in to set a shop at which the mobile terminal 20 is to be used to register the products. The check-in control unit 2003 displays, on the display control unit 2002, a check-in screen when an operation to start registering a product is received. The check-in screen is a screen that prompts the customer to perform an operation necessary for check-in.

When the mobile terminal 20 is owned by the customer, it is initially unknown at which shop the mobile terminal 20 will be used to register products. Therefore, the check-in control unit 2003 sets a shop at which the mobile terminal 20 will be used to register products to be purchased. The check-in control unit 2003 is an example of a setting unit. For example, the check-in screen is a screen that prompts the imaging unit 240 of the mobile terminal 20 to image a code symbol such as a two-dimensional code indicating a shop code for identifying a shop or store. The mobile terminal 20 receives an input of the shop code by decoding the code symbol included in image data acquired by the imaging unit 240. When the shop code is input, the mobile terminal 20 identifies the shop. In other words, the mobile terminal 20 identifies the accounting devices 30 which can be reserved. The check-in control unit 2003 may specify the shop code by a method other than reading a code symbol. For example, the check-in control unit 2003 may receive the input of the shop code by a user operation, may receive the input of the shop code by short-range wireless communication, may specify the shop code by connecting to a wireless local area network (LAN) router such as a Wi-Fi router disposed in the shop, may specify the shop code by comparing mobile terminal position information indicating the position of the mobile terminal 20 as acquired from a global navigation satellite system (GLASS) such as a global positioning system (GPS) to known shop position information or may receive the input of the shop code by another method.

The product registration unit 2004 registers each product to be purchased by the customer. More specifically, when the check-in ends, the product registration unit 2004 displays the product registration screen 2100 on the display control unit 2002. The product registration unit 2004 receives the input of a product code for identifying a product on the product registration screen 2100. The product code is an example of the product identification information. The product registration unit 2004 is an example of an input unit.

For example, the product registration unit 2004 receives the input of the product code by decoding a barcode image included in the image data acquired by the imaging unit 240. The product registration unit 2004 may receive the input of the product code by a user input operation or may receive the input of the product code by another method.

The product registration unit 2004 acquires product information corresponding to the input product code. The product information is information about the product such as the name of the product, the price of the product, and the discount amount of the product. The product registration unit 2004 may acquire the product information from the storage unit 220 or may acquire the product information from a server device that stores product information about the products displayed in the shop identified by the check-in. The product registration unit 2004 generates the product registration information including the acquired product information. The product registration unit 2004 transmits the product registration information to a server device such as the management server 10. The product registration unit 2004 may transmit the product information to a server device to generate a list of the product registration information at the server device or may transmit the product registration information to the server device after all product registration is completed.

The reservation registration unit 2005 controls registration of the reservations for an accounting device 30. For example, the reservation registration unit 2005 receives a reservation in which a reservation time for using the accounting device 30 is specified. The reservation registration unit 2005 is an example of a reception unit. When the mobile terminal 20 is owned by the customer, the reservation registration unit 2005 receives the reservation after the check-in by the check-in control unit 2003 for setting a shop in which the product is registered.

More specifically, when the reservation time is input in the reservation time input area 2210 of the account reservation screen 2200, the reservation registration unit 2005 transmits by the communication control unit 2001 the reservation request information for requesting the reservation about the accounting device 30. The reservation request information includes the reservation time input to the reservation time input area 2210 of the account reservation screen 2200.

When the communication control unit 2001 receives the reservation success or failure information as a response to the reservation request information, the reservation registration unit 2005 displays a screen corresponding to the success or failure of the reservation on the display control unit 2002. The reservation registration unit 2005 displays the reservation success screen 2300 when the reservation success or failure information indicates success of the reservation, and displays the reservation failure screen 2400 when the reservation success or failure information indicates failure of the reservation. The reservation registration unit 2005 stores the reservation content of the accounting device 30 in the storage unit 220.

When the remaining time until the reserved reservation time is less than a set time, the reservation registration unit 2005 displays the reminder screen 2500 on the display control unit 2002. The reminder time may be set for each customer, for each shop, or uniformly across different shops and customers. The reservation registration unit 2005 may display the reminder screen 2500 when the communication control unit 2001 receives the notification indicating that the time is less than the set time, or may display the reminder screen 2500 due to another event.

When the reserved reservation time elapsed, the reservation registration unit 2005 cancels the reservation content stored in the storage unit 220. For example, the reservation registration unit 2005 may delete the reservation content stored in the storage unit 220, or may store information indicating that the reservation content stored in the storage unit 220 is cancelled. Thus, by cancelling the reservation content, the reservation registration unit 2005 prevents an output of the reservation identification information to the accounting device 30. That is, the reservation registration unit 2005 does not display the reservation identification information to be read by the accounting device 30.

The account output unit 2006 outputs the reservation identification information corresponding to the reservation for the accounting device 30. The account output unit 2006 is an example of an output unit. More specifically, when the accounting device 30 is reserved, the account output unit 2006 outputs the reservation identification information. That is, the account output unit 2006 displays on the display control unit 2002 an account information output screen on which the code symbol including the reservation identification information is displayed.

When the accounting device 30 is not reserved or when the reservation about the accounting device 30 is cancelled, the account output unit 2006 displays on the display control unit 2002 an account information output screen on which a code symbol including no reservation identification information is displayed. That is, when the display control unit 2002 displays the reservation cancellation screen, the account output unit 2006 does not output the reservation identification information. The account output unit 2006 is not limited to displaying the code symbol, and may output the reservation identification information by short-range wireless communication, or may output the reservation identification information by another method.

The processor included in the control unit 110 of the management server 10 loads the control program 121 stored in the storage unit 120 into the RAM and operates in accordance with the control program 121 to generate various functional units in the RAM. Accordingly, the control unit 110 of the management server 10 provides, as the functional units, a communication control unit 1001 and a reservation management unit 1002.

The communication control unit 1001 controls the communication unit 130 to communicate with the mobile terminal 20 and the accounting device 30. For example, the communication control unit 1001 receives, from the mobile terminal 20, the reservation request information for requesting the reservation about the accounting device 30. The communication control unit 1001 transmits, to the mobile terminal 20, the reservation success or failure information indicating success or failure of the reservation about the accounting device 30. The communication control unit 1001 transmits, to the accounting device 30, the reservation notification information indicating that the reservation is made.

The reservation management unit 1002 manages the reservation for an accounting device 30 that is reservable. When the communication control unit 1001 receives the reservation request information, the reservation management unit 1002 determines whether an accounting device 30 is reservable at the reservation time included in the reservation request information. For example, the reservation management unit 1002 determines, based on the reservation status of the accounting devices 30 in the reservation list information 122, whether there is the accounting device 30 that is available at the reservation time included in the reservation request information.

When there is an accounting device 30 that is available at the reservation time, the reservation management unit 1002 determines that an accounting device 30 is reservable. That is, the reservation management unit 1002 determines that the reservation succeeded. When there is no accounting device 30 that is available at the reservation time, the reservation management unit 1002 determines that no accounting device 30 is presently reservable at the requested time. That is, the reservation management unit 1002 determines that the reservation failed.

When the reservation can be made, the reservation management unit 1002 generates the reservation content information. The reservation management unit 1002 associates the reservation content information with the accounting device code of the accounting device 30 that is reservable. The reservation management unit 1002 generates the reservation content information including the reservation identification information, the start time point indicated by the reservation time, and the restriction period for restricting use by a customer other than the customer who has a reservation.

The reservation identification information may be a fixed value, a random value, the customer code for identifying the customer who has a reservation, the mobile terminal code for identifying the mobile terminal 20, a reservation code for identifying the reservation about the accounting device 30, or other identification information.

When the accounting device 30 is in use by another customer immediately before the reservation start time point, the customer who has a reservation cannot use the accounting device 30 until the previous user finishes. Likewise, while the customer who has a reservation is using the accounting device 30, a customer who has no reservation cannot use the accounting device 30. Therefore, the reservation management unit 1002 sets, as the restriction period, a period from a set period before the start time point to an end time point at which the use of the accounting device 30 is estimated to normally end. The set period may be a fixed arbitrary value or a calculated value. The period until the end time point may be a fixed value, a value calculated based on the number of registered products, or a value other than these values.

The reservation management unit 1002 transmits by the communication control unit 1001 the reservation notification information to the accounting device 30 to be reserved. The reservation notification information may include the reservation identification information.

The reservation management unit 1002 transmits by the communication control unit 1001 the reservation success or failure information indicating the success or failure of the reservation about the accounting device 30. That is, the communication control unit 1001 transmits the reservation success or failure information to the mobile terminal 20 to which the reservation request information is transmitted. When the reservation for the accounting device 30 succeeds, the reservation management unit 1002 may transmit the reservation success or failure information including the reservation identification information and the accounting device code indicating the reserved accounting device 30. The mobile terminal 20 may display the reserved accounting device 30 based on the accounting device code.

When the reservation for an accounting device 30 fails, the reservation management unit 1002 may transmit the reservation success or failure information including the time at which an accounting device 30 is reservable. For example, the reservation management unit 1002 detects, from the reservation list information 122, an available time of the accounting device 30 close to the start time point indicated by the requested reservation time. The reservation management unit 1002 may transmit the reservation success or failure information including the time at which an accounting device 30 is reservable. Accordingly, when the reservation for an accounting device 30 fails, the mobile terminal 20 can display the time at which an accounting device 30 is reservable.

The processor included in the control unit 310 of the accounting device 30 loads the control program 321 stored in the storage unit 320 into the RAM and operates according to the control program 321 to generate functional units in the RAM. Accordingly, the control unit 310 of the accounting device 30 includes as the functional units: a communication control unit 3001, a display control unit 3002, a reservation collating unit 3003, and an accounting unit 3004.

The communication control unit 3001 controls the communication unit 330 to communicate with the management server 10. For example, the communication control unit 3001 receives, from the management server 10, the reservation notification information indicating that the device is reserved.

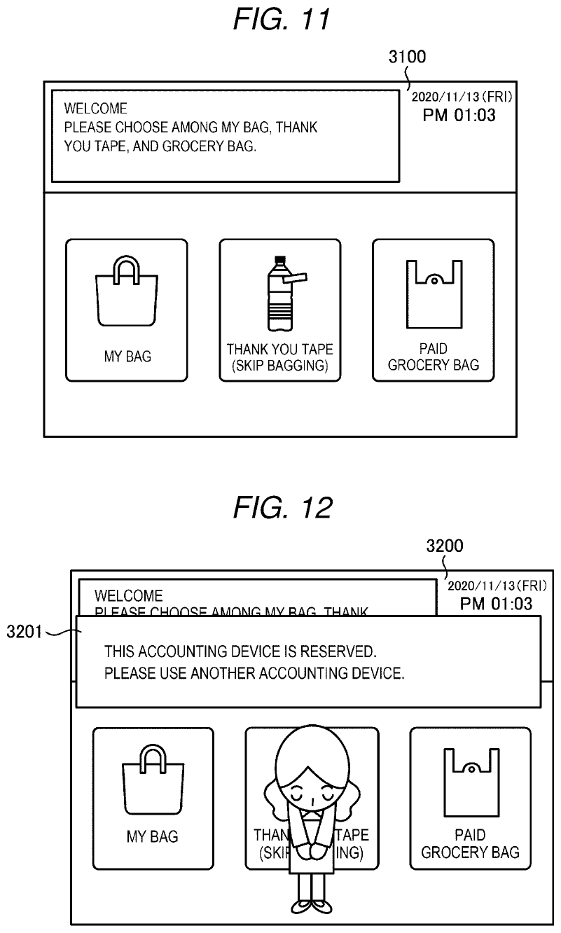

The display control unit 3002 controls the display unit 350 to display various screens on the display unit 350. For example, the display control unit 3002 displays a reception screen 3100 when accounting operations can be received. FIG. 11 is a diagram illustrating an example of the reception screen 3100. The reception screen 3100 is a screen indicating settlement operations can be received. For example, the reception screen 3100 permits an input operation of selecting an operation method for settlement by the customer. For example, the reception screen 3100 receives an input for selecting a take-out method for the purchased products. Specifically, the reception screen 3100 receives selection indicating a preference for using a brought bag (“My Bag” option), using a tape indicating that the product has been purchased, or putting the products into a store bag (available for purchase).

FIG. 12 is a diagram illustrating an example of an in-reserve screen 3200. The in-reserve screen 3200 is a screen that indicates that the device is presently reserved and thus cannot be used without a reservation. When the communication control unit 3001 receives the reservation notification information, the display control unit 3002 displays the in-reserve screen 3200 during the restriction period included in the reservation notification information. When the accounting device 30 is used immediately before the start time point, the customer who has a reservation cannot use the accounting device 30. Therefore, the display control unit 3002 displays the in-reserve screen 3200 slightly before the nominal reservation start time point.

For example, the in-reserve screen 3200 displays a message that “This accounting device is reserved. Please use another accounting device.” Here, the accounting device 30 compares the input reservation identification information with the provided reservation identification information to determine whether the customer has a reservation. That is, the accounting device 30 determines whether to permit the use of the account device 30. Therefore, the accounting device 30 may include a message or an image prompting the input of the reservation identification information, and a message or an image indicating an input method of the reservation identification information.

The display control unit 3002 displays an account screen when the accounting is being executed. The account screen includes a list of the product information for the products registered by the mobile terminal 20 and an accounting button. According to the list of the product information, the customer confirms the registered product to be purchased. The accounting button is a button for receiving the account operation.

The reservation collating unit 3003 determines whether the customer who intends to use the device has a reservation. More specifically, the reservation collating unit 3003 receives the input of the reservation identification information. For example, the reservation collating unit 3003 controls the scanner 340 to read the code symbol (such as a barcode or a two-dimensional code) displayed on the display unit 250 of the mobile terminal 20. The reservation collating unit 3003 receives the input of the reservation identification information by decoding the read code symbol. The reservation collating unit 3003 determines, based on the input reservation identification information, whether the customer reserved the device.

When the communication control unit 3001 receives the reservation notification information including the reservation identification information, the reservation collating unit 3003 compares the previously received reservation identification information with the input reservation identification information. When the previously received reservation identification information coincides with the input reservation identification information, the reservation collating unit 3003 determines that the customer is the customer who has a reservation. On the other hand, when the previously received reservation identification information does not coincide with the input reservation identification information, the reservation collating unit 3003 determines that the customer does not have reservation (at least for the particular accounting machine 30).

The reservation collating unit 3003 may transmit the input reservation identification information to the management server 10. In this case, the management server 10 may compare the previously set reservation identification information with the just input reservation identification information. The reservation collating unit 3003 determines, based on an collating result received from the management server 10, whether the customer has a reservation. The reservation collating unit 3003 is not limited to reading the reservation identification information by the scanner 340, and may instead or in addition receive the input of the reservation identification information by a user input operation or by short-range wireless communication.

If the reservation identification information is not input by the reserved start time point, the reservation collating unit 3003 determines that the reservation was cancelled. When the reservation collating unit 3003 determines that the reservation has been cancelled, the display control unit 3002 switches the in-reserve screen 3200 to the reception screen 3100. That is, the accounting device 30 may now be used by a customer who has no reservation.

During the restriction period, the accounting unit 3004 will only perform settlement operations if the reservation collating unit 3003 determines that the particular customer has a reservation. For example, the accounting unit 3004 downloads the product registration information using the acquisition information included in the code symbol as read by the reservation collating unit 3003. The accounting unit 3004 then performs settlement based on this product registration information.

When the current time point is not in the restriction period, the reservation collating unit 3003 does not attempt to collate the reservation identification information, and thus does not attempt to read a reservation code symbol or the like. However, the accounting unit 3004 may read a code symbol including the acquisition information displayed on the mobile terminal 20. The accounting unit 3004 downloads the product registration information using the acquisition information. The accounting unit 3004 calculates the total amount by summing up the prices included in the product registration information. The accounting unit 3004 calculates change due in the transaction by subtracting the total amount from the amount of money deposited into the depositing and dispensing unit 370. The accounting unit 3004 dispenses the change from the depositing and dispensing unit 370. As a method for acquiring the acquisition information, the accounting unit 3004 is not limited to reading a code symbol, and may instead or in addition acquire the acquisition information by receiving the acquisition information from the mobile terminal 20 by short-range wireless communication, from another device such as the management server 10, or by another method.

Next, processing executed by various devices of the self-checkout system 1 will be described.

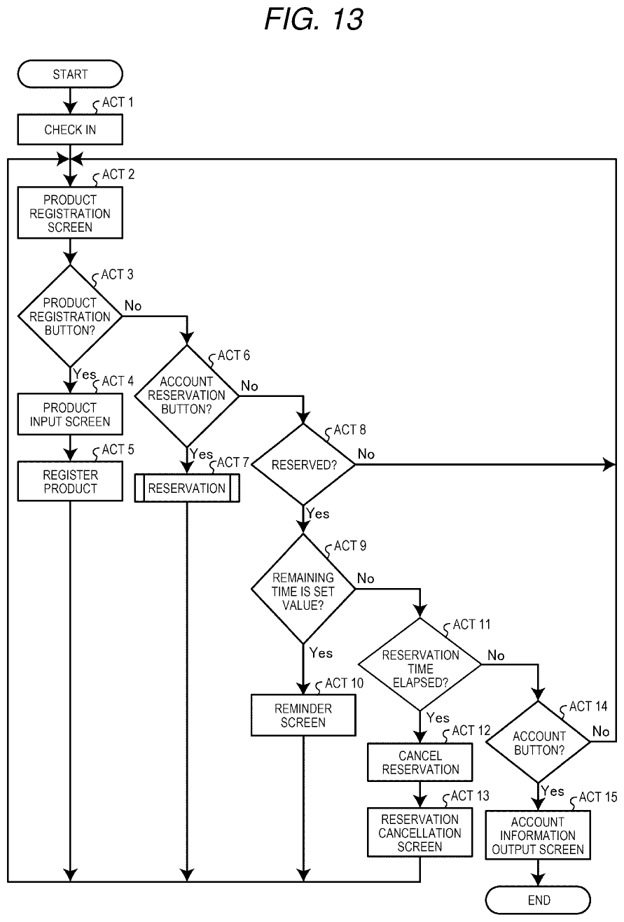

FIG. 13 is a flowchart illustrating an example of the account reservation executed by the mobile terminal 20 according to the present embodiment.

The check-in control unit 2003 checks in to set a shop in which the mobile terminal 20 registers the product (Act 1).

The display control unit 2002 displays the product registration screen 2100 (Act 2).

The display control unit 2002 determines whether the product registration button 2103 of the product registration screen 2100 was pressed (Act 3).

When the product registration button 2103 is pressed (Yes in Act 3), the display control unit 2002 displays a product input screen (Act 4).

The product registration unit 2004 registers the product to be purchased on the product input screen (Act 5). The mobile terminal 20 proceeds to Act 2.

When the product registration button 2103 is not pressed (No in Act 3), the display control unit 2002 determines whether the account reservation button 2104 of the product registration screen 2100 was pressed (Act 6).

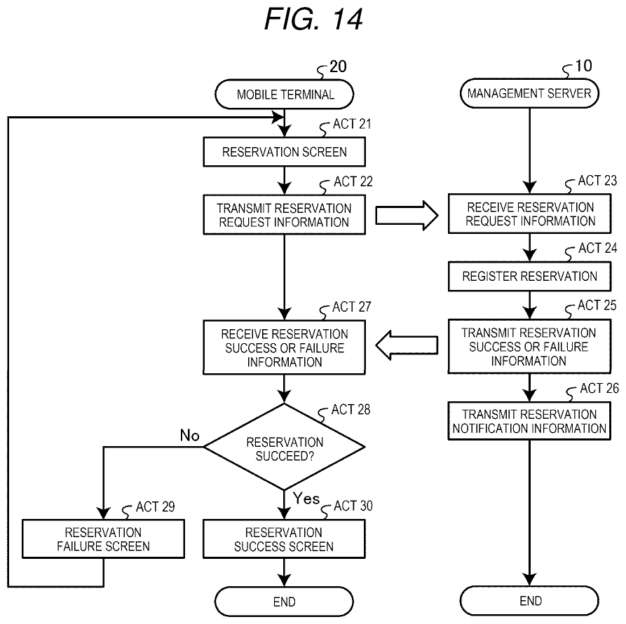

When the account reservation button 2104 is pressed (Yes in Act 6), the mobile terminal 20 executes the reservation processing illustrated in FIG. 14 together with the management server 10 (Act 7). The mobile terminal 20 then proceeds to Act 2.

When the account reservation button 2104 is not pressed (No in Act 6), the reservation registration unit 2005 determines whether the accounting device 30 has been reserved (Act 8). That is, the reservation registration unit 2005 determines whether the reservation content of the accounting device 30 is stored in the storage unit 220. When the accounting device 30 is not reserved (No in Act 8), the mobile terminal 20 proceeds to Act 2.

When the accounting device 30 is reserved (Yes in Act 8), the reservation registration unit 2005 next determines whether the remaining time until the reserved reservation time is a set value (Act 9).

When the remaining time is the set value (Yes in Act 9), the display control unit 2002 displays the reminder screen 2500 (Act 10). The mobile terminal 20 proceeds to Act 2.

When the remaining time is not the set value (No in Act 9), the reservation registration unit 2005 determines whether the reserved reservation time elapsed (Act 11).

When the reserved reservation time elapsed (Yes in Act 11), the reservation registration unit 2005 cancels the reservation about the accounting device 30 (Act 12). That is, the reservation registration unit 2005 stores the cancellation of the reservation in the storage unit 220.

The display control unit 2002 displays the reservation cancellation screen indicating that the reservation about the accounting device 30 is cancelled (Act 13). The mobile terminal 20 proceeds to Act 2.

When the reserved reservation time does not elapse (No in Act 11), the display control unit 2002 next determines whether the account button 2105 of the product registration screen 2100 has been pressed (Act 14). When the account button 2105 has not been pressed (No in Act 14), the mobile terminal 20 proceeds to Act 2.

When the account button 2105 has been pressed (Yes in Act 14), the display control unit 2002 displays the account information output screen including the code symbol to be read by the accounting device 30 (Act 15).

Accordingly, the mobile terminal 20 ends the account reservation processing.

FIG. 14 is a flowchart illustrating an example of a reservation executed by the mobile terminal 20 and the management server 10 according to the present embodiment.

The display control unit 2002 of the mobile terminal 20 displays the account reservation screen 2200 for reserving an accounting device 30 (Act 21). The communication control unit 2001 of the mobile terminal 20 transmits, to the management server 10, the reservation request information for requesting the reservation of the accounting device 30 at the reservation time specified on the account reservation screen 2200 (Act 22).

The communication control unit 1001 of the management server 10 receives the reservation request information from the mobile terminal 20 (Act 23).

The reservation management unit 1002 of the management server 10 reserves, based on the reservation request information, the accounting device 30 at the reservation time specified by the reservation list information 122 (Act 24). That is, the reservation management unit 1002 determines whether the accounting device 30 is reservable at the requested reservation time. The reservation management unit 1002 reserves the accounting device 30 when the reservation can be made.

The communication control unit 1001 of the management server 10 transmits, to the mobile terminal 20, the reservation success or failure information indicating whether the reservation requested by the reservation request information succeeded (Act 25).

The communication control unit 1001 of the management server 10 transmits the reservation notification information to the reserved accounting device 30 (Act 26).

The communication control unit 2001 of the mobile terminal 20 receives the reservation success or failure information from the management server 10 (Act 27).

The display control unit 2002 of the mobile terminal 20 determines whether the reservation success or failure information indicates the success of the reservation about the accounting device 30 (Act 28).

When the reservation success or failure information indicates the reservation failure of the accounting device 30 (No in Act 28), the display control unit 2002 displays the reservation failure screen 2400 (Act 29).

When the reservation success or failure information indicates the reservation success of the accounting device 30 (Yes in Act 28), the display control unit 2002 displays the reservation success screen 2300 (Act 30).

Accordingly, the mobile terminal 20 ends the reservation.

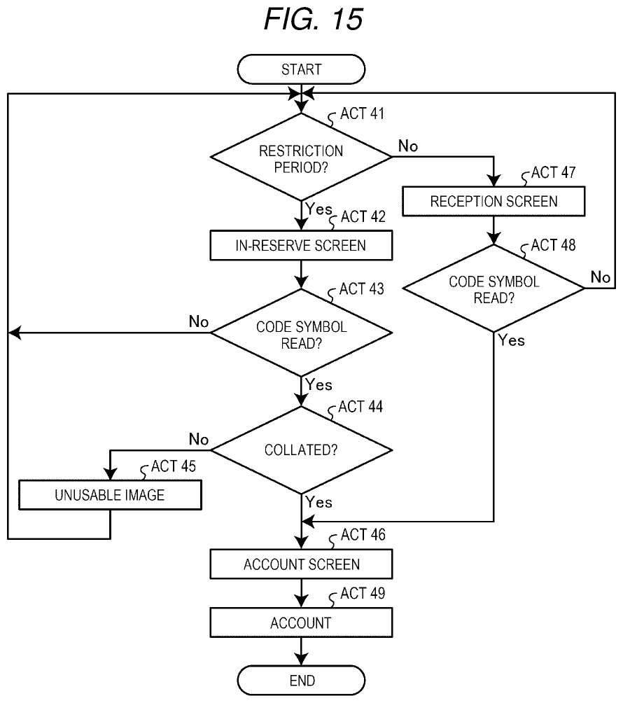

FIG. 15 is a flowchart illustrating an example of the reserved accounting process executed by the accounting device 30 according to the present embodiment.

The reservation collating unit 3003 determines whether the current time point is in the restriction period during which the use by a customer who has no reservation is prevented (Act 41).

When the current time point is in the restriction period (Yes in Act 41), the display control unit 3002 displays the in-reserve screen 3200 indicating that the accounting device 30 is reserved (Act 42).

The reservation collating unit 3003 determines whether a code symbol including the reservation identification information and the acquisition information has been read (Act 43). That is, the reservation collating unit 3003 determines whether the reservation identification information used for determining whether the customer has reserved the accounting device 30 has been input.

When the reservation identification information is not input (No in Act 43), the accounting device 30 proceeds to Act 41.

When the reservation identification information is input (Yes in Act 43), the reservation collating unit 3003 determines, based on the input reservation identification information, whether the customer has a reservation (Act 44). That is, the reservation collating unit 3003 acquires a determination result as to whether the input reservation identification information coincides with the collative reservation identification information of the reservation list information 122.

When the customer is not the customer who has the reservation (No in Act 44), the display control unit 3002 displays an unusable image indicating that the accounting device 30 is reserved and thus cannot be used (Act 45). The accounting device 30 then proceeds to Act 41.

When the customer is the customer who has the reservation (Yes in Act 44), the display control unit 3002 displays the account screen indicating the content related to the accounting process (Act 46).

When it is determined in Act 41 that the current time point is not in the restriction period (No in Act 41), the display control unit 3002 displays the reception screen 3100 (Act 47).

The accounting unit 3004 determines whether a code symbol including acquisition information has been read (Act 48).

When a code symbol is not yet read (No in Act 48), the mobile terminal 20 proceeds to Act 41. On the other hand, when the code symbol is read (Yes in Act 48), the mobile terminal 20 proceeds to Act 46.

The accounting unit 3004 performs settlement processing based on the product registration information downloaded (or otherwise acquired) using the acquisition information (Act 49).

Accordingly, the mobile terminal 20 ends the reserved accounting process.

In this way, the mobile terminal 20 according to the present embodiment can receive the input of product codes to register products to be purchased. The mobile terminal 20 may also make a reservation by which the use of an accounting device 30 for accounting operations on the registered products is reserved as specified on the account reservation screen 2200. In order to collate the reservation identification information, the mobile terminal 20 outputs the reservation identification information corresponding to the reservation to the accounting device 30. Accordingly, only the customer who reserved the accounting device 30 can use the accounting device 30 during the restricted (reserved) time period. On the other hand, any other customer who did not reserve the particular accounting device 30 cannot use the accounting device 30 during this restricted time period. Therefore, certain mobile terminal 20 users can have a reduced waiting time for an accounting device 30.

The program executed by each device of the above embodiment and modifications is provided by being incorporated in a storage medium (ROM or storage unit) included in the device in advance. However, the present disclosure is not limited thereto. For example, a program may be provided by being recorded in a non-transitory computer-readable recording medium such as a CD-ROM, a flexible disk (FD), a CD-R, or a digital versatile disk (DVD) as a file in an installable format or an executable format. The storage medium may be accessed through a local area network (LAN), the Internet, or the like and downloaded or otherwise accessed.

While certain embodiments have been described, these embodiments have been presented by way of example only, and do not limit the scope of the present disclosure. Indeed, the novel embodiments described herein may be embodied in a variety of other forms; furthermore, various omissions, substitutions and changes in the form of the embodiment described herein may be made without departing from the spirit of the present disclosure. Such embodiments and modifications thereof are included in the scope and spirit of the present disclosure and the claims and equivalents in scope thereof.

What is claimed is:

1. A mobile terminal, comprising:
a communication interface connectable to a reservation management server;
a display screen; and
a processor configured to:
receive an input of product identification information for identifying a product to be purchased in a sales transaction;
display a reservation request screen on the display screen to receive a reservation request in which a reservation time for using an accounting device for settlement processing of the sales transaction is set;
send the reservation request to the reservation management server via the communication interface;
receive a reservation request response from the reservation management server via the communication interface, the reservation request response including reservation information when the reservation request is accepted by the reservation management server; and
output identification information corresponding to the reservation information if the reservation request is accepted by the reservation management server.

2. The mobile terminal according to claim 1, wherein the identification information is output to the display screen.

3. The mobile terminal according to claim 1, wherein the processor is further configured to track a current time and compare the reservation time to the current time when the reservation request is accepted by the reservation management server.

4. The mobile terminal according to claim 3, wherein the processor is further configured to:
display a cancellation screen on the display screen indicating that the reservation has been cancelled if a time period corresponding to the reservation time elapses.

5. The mobile terminal according to claim 4, wherein the processor is further configured to:
delete the identification information after the display the cancellation screen is displayed on the display screen.

6. The mobile terminal according to claim 3, wherein the process is further configured to:
display a reminder screen on the display screen indicating a remaining time before the reservation time.

7. The mobile terminal according to claim 1, wherein the identification information corresponding to the reservation information is output as a code symbol to the display screen.

8. The mobile terminal according to claim 7, wherein the code symbol also corresponds to registered product information for products to be purchased in the sales transaction.

9. A method for a mobile terminal in a self-service retail checkout system, the method comprising:
receiving an input of product identification information for identifying a product to be purchased in a sales transaction;
displaying a reservation request screen on a display screen to receive a reservation request in which a reservation time for using an accounting device for settlement processing of the sales transaction is set;
sending the reservation request to a reservation management server via a communication interface;
receiving a reservation request response from the reservation management server via the communication interface, the reservation request response including reservation information when the reservation request is accepted by the reservation management server; and
outputting identification information corresponding to the reservation information if the reservation request is accepted by the reservation management server.

10. The method according to claim 9, wherein the identification information is output to the display screen.

11. The method according to claim 9, further comprising:
tracking a current time and comparing the reservation time to the current time if the reservation request is accepted by the reservation management server.

12. The method according to claim 11, further comprising:
displaying a cancellation screen on the display screen indicating that the reservation has been cancelled if a time period corresponding to the reservation time elapses.

13. The method according to claim 12, further comprising:
deleting the identification information after the display the cancellation screen is displayed on the display screen.

14. The method according to claim 11, further comprising:
displaying a reminder screen on the display screen indicating a remaining time before the reservation time.

15. The method according to claim 9, wherein the identification information corresponding to the reservation information is output as a code symbol to the display screen.

16. The method according to claim 15, wherein the code symbol also corresponds to registered product information for products to be purchased in the sales transaction.

17. A self-service retail checkout system, comprising:
a plurality of accounting machines configured to receive payments for sales transactions;
a management server communicably connected to the plurality of accounting machines and configured to manage reservations for the plurality of accounting machines; and
a mobile terminal including:
a communication interface connectable to the management server;
a display screen; and
a processor configured to:
receive an input of product identification information for identifying a product to be purchased in a sales transaction;
display a reservation request screen on the display screen to receive a reservation request in which a reservation time for using an accounting device for settlement processing of the sales transaction is set;
send the reservation request to the management server via the communication interface;
receive a reservation request response from the management server via the communication interface, the reservation request response including reservation information when the reservation request is accepted by the reservation management server; and
output identification information corresponding to the reservation information if the reservation request is accepted by the management server.

18. The system according to claim 17, wherein the identification information is output to the display screen.

19. The system according to claim 17, wherein
the identification information corresponding to the reservation information is output as a code symbol to the display screen, and
each accounting machine includes a code scanner to read the code symbol.

20. The system according to claim 19, wherein the code symbol also corresponds to registered product information for products to be purchased in the sales transaction.
